(19) United States
(12) Patent Application Publication
(10) Pub. No.: US 2026/0022779 A1
(43) Pub. Date: Jan. 22, 2026

(54) Breathable Plug Fixture

(71) Applicant: Illinois Tool Works Inc., Glenview, IL (US)

(72) Inventor: Fulvio Pacifico Yon, Donnas (IT)

(21) Appl. No.: 19/272,303

(22) Filed: Jul. 17, 2025

(30) Foreign Application Priority Data
Jul. 19, 2024 (EP) 24189834.5
Jun. 25, 2025 (DE) 10 2025 124 546.0

(51) Int. Cl. F16K 24/00

(52) U.S. Cl. CPC F16K 24/00

(57) ABSTRACT

A breathable plug that allows gas to pass through while blocking liquids. The plug includes a base section with an opening designed to hold a plug piece. The plug also has one or more flexible clips on the outside that match the surface of the object it attaches to. The plug piece fits into the opening and has a flexible outer thread that is sized to create a tight push-fit connection with the opening.

### RELATED APPLICATIONS

The present application claims the benefit of European Patent Application No. 24189834.5, filed Jul. 19, 2024, and German Patent Application No. 10 2025 124 546.0, filed Jun. 25, 2025, each titled “Breathable Plug Fixture,” the contents of which are hereby incorporated by reference.

### TECHNICAL FIELD

The present application relates to a breathable plug fixture suitable to simultaneously prevent the passage of liquid and permit the passage of gas.

### BACKGROUND

Electric vehicles are increasingly provided with an electric drive module to convert the stored battery power into movement at the wheels. The electric drive module houses mechanical components which require cooling and lubrication, typically by oil. The system cannot be run in a closed configuration due to oil expansion and also to allow vapor (such as water vapor) to escape the system.

Due to the moving parts oil is splashed around inside the electric drive module, and this can result in the suspension or dispersal of oil droplets which risk escaping through any vent or filter that the system is provided with.

### SUMMARY

The present disclosure relates generally to a breathable plug fixture, substantially as illustrated by and described in connection with at least one of the figures, as set forth more completely in the claims.

### DESCRIPTION OF THE DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1 illustrates a cross section of a breathable plug fixture.

FIGS. 2a and 2b illustrate, respectively, a breathable plug fixture aligned with a substrate prior to fitting and a breathable plug fixture fitted to a substrate.

FIGS. 3a and 3b illustrate, respectively, a partial cross section of a breathable plug fixture in an unlocked position and a partial cross section of a breathable plug fixture in a locked position.

FIG. 4 illustrates a cross section of an alternative breathable plug fixture.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The disclosure relates to a breathable plug fixture that is suitable to simultaneously prevent the passage of liquid and permit the passage of gas, the breathable plug fixture comprising: a fixation portion comprising an aperture configured to receive a plug portion and one or more external resilient clips having a surface complementary to a substrate surface, a plug portion associated with the aperture, the plug portion comprising a resilient external thread having a dimension sufficient to form an interference push fit with the aperture. The breathable plug fixture provides a fitting that can be push-fit or clipped into a panel of a vehicle and thereby form a fluid tight (gas and liquid) seal between the panel and the breathable plug fixture.

Suitably, the breathable plug fixture further comprises a lock configured to fix the position of the plug portion relative to the fixation portion, such that the plug portion may be held in a given position (e.g., held open or shut or an indeterminate position) and thereby resist unintentional operation.

Preferably, the surface complementary to a substrate surface is a threaded surface to assist removal of the breathable plug fixture, as while push-fit, the breathable plug fixture may be subsequently removed from the panel by rotating the breathable plug fixture out of the threaded surface.

Appositely, the resilient external thread, when in use, permits the passage of gas but prevents the passage of liquid, thereby allowing, for example, water vapor to escape but retain oil droplets.

Suitably, the breathable plug fixture further comprises at least one guide portion configured to facilitate reception of the plug portion by the fixation portion. This ensures the correct fitment of the plug portion within the fixation portion and avoids misalignment.

Preferably, the breathable plug fixture further comprises at least one resilient seal, configured to, in use, compress against a substrate surface and apply a tension between the fixation portion and the substrate surface. This ensures a fluid-tight seal between the breathable plug fixture and the substrate surface.

Appositely, the plug portion is captured by the fixation portion, thereby preventing misplacement of the plug portion.

Suitably, the plug portion is sized to be push-fit within the fixation portion, ensuring no extra movements or tools are required by an operative to fit the plug portion.

Preferably, the resilient external thread provides a conduit for a liquid to return to a side. The resilient external thread allows, for example, oil droplets which have collected upon a flank of a thread to trickle down the resilient external thread and drip out of the breathable plug fixture into, for example, an oil tank.

Appositely, the fixation portion further comprises a frame.

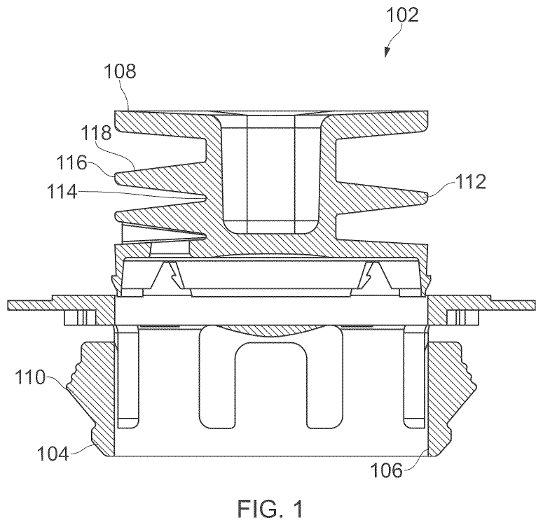

As shown in FIGS. 1, 2a, 2b, 3a, and 3b there is provided a breathable plug fixture 102 suitable for simultaneously preventing the passage of liquid (typically oil) and permit the passage of gas (such as water vapor).

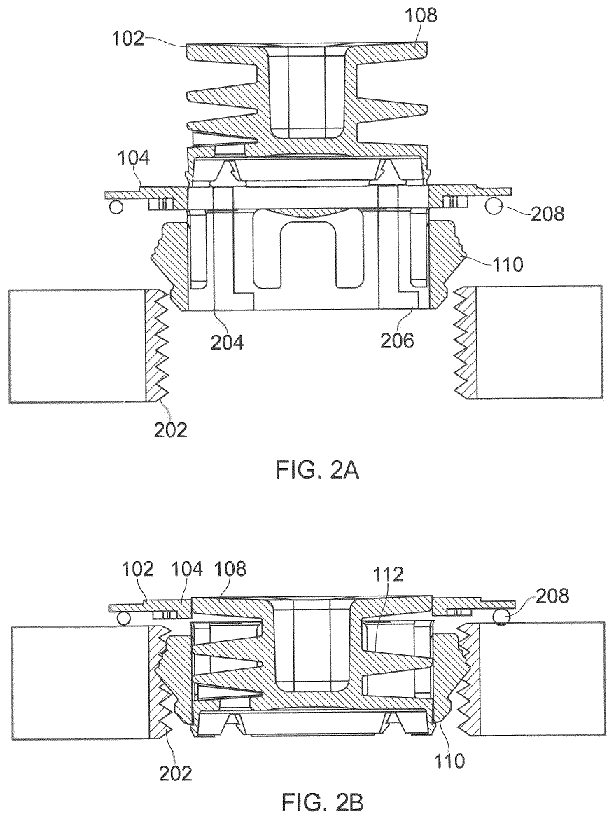

The breathable plug fixture comprises a fixation portion 104 comprising an aperture 106 configured to receive a plug portion 108 and one or more external resilient clips 110 having a surface complementary to a substrate surface. A frame may be provided to form a body of the fixation portion 104 and in which the aperture 106 may be formed. The frame also provides a substrate from which external resilient clips 110 may be formed or attached. The fixation portion 104 provides a connector between the breathable plug fixture 102 and a vehicle. A seal (not shown in FIG. 1, item 208 in FIGS. 2a and 2b) is provided between a lip of the fixation portion 104 to interface with a surface of the vehicle (substrate), although it will be apparent that a seal may be arranged at any suitable location on the fixation portion 104 provided the function of sealing the connection is provided (i.e. Preventing the passage of both liquid and gaseous fluids). The at least one resilient seal 208, is configured to, in use, compress against a substrate surface and apply a tension between the fixation portion and the substrate surface. This prevents unintentional separation of the parts. The at least one resilient seal 208 also provides increased sealing with increasing pressure as this results in greater compression of the seal between the fixation portion 104 and the substrate.

The external resilient clips 110 provide gripping means for the fixation portion 104 to grasp and be retained within the vehicle substrate. By making the external resilient clips 110 resilient, fitting time of the breathable plug fixture 102 is reduced as the fixation portion 104 may simply be pushed into place with a “snap-fit” (i.e. The part does not need screwing or welding into place). The surface complementary to a substrate surface (i.e. The surface of the vehicle to which the fixation portion 104 is fitted) is a threaded surface, in order to provide a more effective connection between the parts.

As the location of the breathable plug fixture 102 is likely to experience relatively elevated temperatures, through the drive means heating up in use, the fixation portion 104 should be formed of a material appropriate to deal with such temperatures, such as a suitable plastic.

A plug portion 108 is associated with the aperture. The breathable plug fixture 102 may be supplied with the plug portion 108 captured by the fixation portion 104 in the aperture or partially inserted into the aperture. The plug portion has a resilient external thread 112 having a dimension sufficient to form an interference push fit with the aperture. In this way the plug portion 108 can be fitted to the aperture simply by pushing the plug portion 108 inside. The aperture does not therefore comprise complementary threads and may have a smooth side wall. The resilient external thread 112 may act as a conduit for returning oil to the vehicle, which may trickle down the resilient external thread.

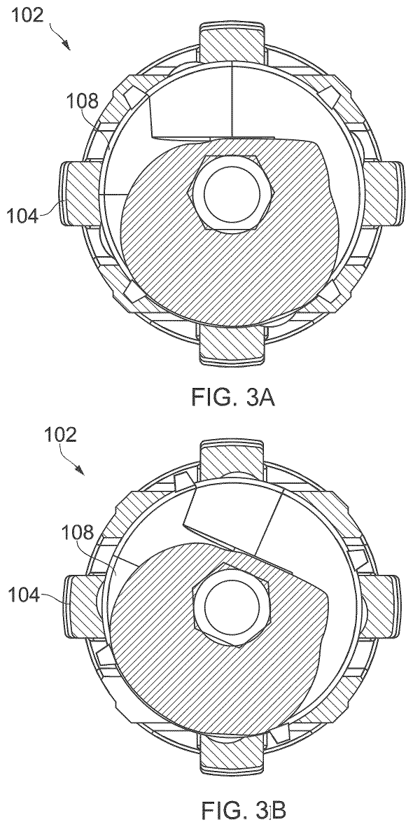

The breathable plug fixture further comprises a lock 206 configured to fix the position of the plug portion relative to the fixation portion. The lock ensures that the plug portion 108 is securely held in place in the aperture of the fixation portion 104 and will not unintentionally disassociate from the fixation portion 104, for example, through road vibrations. The lock may take the form of a slot into which teeth may be rotated, similar to a bayonet fitting. The rotation to affect a secure lock may be minimal, for example. With reference to FIGS. 3a and 3b, the lock may be engaged through a rotation of an eighth of a turn or less. Preferably the lock may be engaged by hand, without any additional tools. The plug portion 108 may be provided with an interface to engage with a tool (such as a spanner, hex key, star driver or any similar) to allow for rotation of the plug portion 108 which may operate the lock 206 or allow the plug portion 108 to be rotated out of the aperture via the resilient external thread.

Preferably, the resilient external thread, when in use, permits the passage of gas but prevents the passage of liquid. This may be affected by selecting an appropriate pitch or number of threads to provide a labyrinth or riddle through which liquid may not pass, but gas may.

The breathable plug fixture can further comprise at least one guide portion 204 configured to facilitate reception of the plug portion by the fixation portion. The at least one guide portion 204 may be a slot and running member arranged on either the plug portion or fixation portion respectively. The guide ensures the correct location and fitment of the parts and also sops rotation of the part in the aperture.

FIGS. 2a and 2b shows the fitment of the breathable plug fixture 102. The fixation portion 104 is pushed into, for example, a threaded hole in the vehicle. The breathable plug fixture 102 is then fully pushed into the fixation portion 104. The breathable plug fixture 102 may then be locked as shown in FIGS. 3a and 3b by rotating the plug portion 108 by hand.

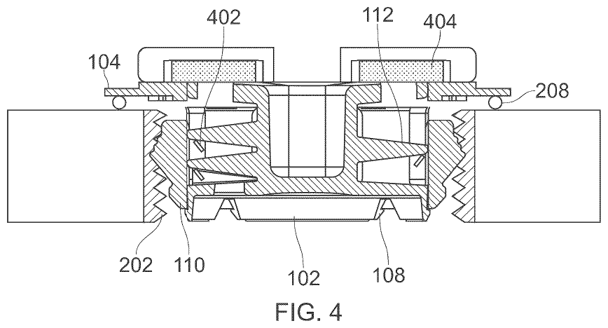

An alternative breathable plug fixture 102 is shown in FIG. 4. The breathable plug fixture 102 is also suitable to simultaneously prevent the passage of liquid and permit the passage of gas and shares many similar features to the breathable plug fixture 102 of FIG. 1. These are provided with like numerals and not further discussed in order to prevent unnecessary repetition.

The breathable plug fixture comprises a fixation portion 104 comprising an aperture 106 configured to receive a plug portion 108. The plug portion 108 is associated with the aperture and comprises a resilient external thread 112 having a dimension sufficient to form an interference push fit with the aperture.

The resilient external thread further comprises one or more wings 402 arranged between a root 114 and a crest 116 of the resilient external thread. Here, root 114 and crest 116 refer to the properties of a thread. The root 114 is the bottom of the groove between the two flanking surfaces of the thread and the crest 116 is the is the prominent part of a thread (outermost). The flank 118 is the surface of the thread connecting a given crest 116 and root 114.

The purpose of the wings 402 is to capture dispersed oil droplets so they run down the wings 402 and onto the resilient external threads 112 and then trickle back down into the drive unit. So, the one or more wings are configured to capture liquid droplets and/or to direct the captured liquid droplets.

The one or more wings may be arranged within the pitch of the resilient external thread (i.e. the valley formed between two respective crests 116).

The one or more wings can be arranged between a major thread diameter and a minor thread diameter of the resilient external thread, i.e. Between the crest 116 and root 114 of the resilient external thread 112.

To achieve the above arrangements the one or more wings are attached to at least one flank of the resilient external thread, and therefore in the path of any dispersed oil droplets in the resilient external thread. The one or more wings therefore at least partially occlude a gap (or valley as described before) formed between opposing flanks of the resilient external thread.

The plug portion can be further provided with a gas permeable membrane, although this is not essential. The gas permeable membrane may permit gas to escape but capture any remaining dispersed oil droplets which escape the plug portion. The gas permeable membrane may be any suitable such as an aluminum filter, non-woven mesh, membrane or sintered filter. The gas permeable membrane may be added on the top of the plug portion and locked with a cap, over molded, welded, or otherwise suitably fixed to the plug portion.

By using the above-described plug portions of FIG. 1 (the breathable plug fixture 102 of FIG. 1 may also be provided with a gas permeable membrane similar to FIG. 4) and FIG. 4, any attached filter stays cleaner by stopping oil droplets contaminating the filter, therefore a longer duration between services may be permitted.

The breathable plug fixture 102 may be suitable to simultaneously prevent the passage of liquid and permit the passage of gas. The breathable plug fixture comprises a fixation portion 104 comprising an aperture 106 configured to receive a plug portion 108. A plug portion 108 is associated with the aperture. The plug portion comprises a resilient external thread 112 having a dimension sufficient to form an interference push fit with the aperture. The resilient external thread further comprises one or more wings arranged between a root 114 and a crest 116 of the resilient external thread. The one or more wings may be arranged within the pitch of the resilient external thread. Alternatively, or in addition, one or more wings are arranged between a major thread diameter and a minor thread diameter of the resilient external thread. The plug portion may be further provided with a gas permeable membrane. The one or more wings may be configured to capture liquid droplets and/or to direct the captured liquid droplets. The one or more wings may be attached to at least one flank of the resilient external thread. The one or more wings may at least partially occlude a gap formed between opposing flanks of the resilient external thread.

It will be appreciated by persons skilled in the art that the above detailed examples have been described by way of example only and not in any limitative sense, and that various alterations and modifications are possible without departing from the scope of the disclosure as defined by the appended claims. Various modifications to the detailed examples described above are possible.

Through the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

While the present method and/or system have been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A breathable plug fixture (102) suitable to simultaneously prevent the passage of liquid and permit the passage of gas, the breathable plug fixture comprising:
a fixation portion (104) comprising an aperture (106) configured to receive a plug portion (108) and one or more external resilient clips (110) having a surface complementary to a substrate surface; and
a plug portion (108) associated with the aperture, the plug portion comprising a resilient external thread (112) having a dimension sufficient to form an interference push fit with the aperture.

2. The breathable plug fixture of claim 1 wherein the breathable plug fixture further comprises a lock (206) configured to fix the position of the plug portion relative to the fixation portion.

3. The breathable plug fixture of claim 1, wherein the surface complementary to a substrate surface is a threaded surface.

4. The breathable plug fixture of claim 1, wherein the resilient external thread, when in use, permits the passage of gas but prevents the passage of liquid.

5. The breathable plug fixture of claim 1, wherein the breathable plug fixture further comprises at least one guide portion (204) configured to facilitate reception of the plug portion by the fixation portion.

6. The breathable plug fixture of claim 1, further comprising at least one resilient seal (208), configured to, in use, compress against a substrate surface and apply a tension between the fixation portion and the substrate surface.

7. The breathable plug fixture of claim 1, wherein the plug portion (108) is captured by the fixation portion (104).

8. The breathable plug fixture of claim 1, wherein the plug portion (108) is sized to be push-fit within the fixation portion (104).

9. The breathable plug fixture of claim 1, wherein the resilient external thread (112) provides a conduit for a liquid to return to a side of the (102).

10. The breathable plug fixture of claim 1, wherein the fixation portion (104) further comprises a frame.
